(19) United States
(12) Patent Application Publication
(10) Pub. No.: US 2008/0077627 A1
(43) Pub. Date: Mar. 27, 2008

(54) Data management system

(76) Inventor: Masayuki Yachi, Kanagawa (JP)

Correspondence Address: FROMMER LAWRENCE & HAUG LLP, 745 FIFTH AVENUE, NEW YORK, NY, 10151, US

(21) Appl. No.: 11/904,012

(22) Filed: Sep. 25, 2007

(30) Foreign Application Priority Data
Sep. 27, 2006 (JP) P2006-263102

(51) Int. Cl. G06F 17/30

(52) U.S. Cl. 707/200; 707/E17.001

(57) ABSTRACT

A data management system is provided. The data management system has a management terminal for displaying a list of data recorded in a recording apparatus on a screen to perform an operation of giving a command of deleting the data an item of which is displayed in the list on the screen. The data management system includes a non-display processor and a deletion processor. The non-display processor is configured to immediately hide all the items of the data ordered to be deleted in the list on the screen upon receiving the command of deleting the data given with the operation performed at the management terminal. The deletion processor is configured to delete respective data ordered to be deleted from the recording apparatus at specific time intervals after the command of deleting the data is given with the operation performed at the management terminal.

### CROSS REFERENCES TO RELATED APPLICATIONS

The present invention contains subject matter related to Japanese Patent Application JP 2006-263102 filed in the Japanese Patent Office on Sep. 27, 2006, the entire contents of which being incorporated herein by reference.

### BACKGROUND OF THE INVENTION

1. Field of the Invention

The present invention relates to a data management system including a management terminal for performing an operation of giving a command of deleting data recorded in a recording apparatus.

2. Description of the Related Art

Television broadcasting stations typically have an AV server system including a large capacity AV server, a database terminal and a plurality of operation terminals. The large capacity AV server is configured to record AV (Audio and Video) data as broadcasting materials. The database terminal is configured to store a list of the materials recorded in the AV server. The plurality of operation terminals are configured to perform an operation such as recording, editing and management of such broadcasting materials. Those server and terminals are connected through a network.

The applicant of the present invention has previously proposed an AV server system in which load is reduced if there are requests for transferring AV data from a plurality of editing terminals simultaneously given to a video server (refer to Japanese Unexamined Patent Application Publication No. 2004-157615).

However, the load may increase in such AV server system when data recorded in the AV server is deleted. Such load increase is caused under the following circumstances.

After AV data recorded in the AV server is aired, there may be no need to keep the AV data in the AV server. Accordingly, such AV data is typically deleted from the AV server after the data is transferred to separate archives. However, a work of such deletion is not necessarily carried out regularly, and may be carried out collectively when the capacity of the AV server is almost full (e.g., when the number of materials reaches around 1,000). In such a case, the following deletion processing is performed in the AV server system of related art upon receiving a deletion command given from a management terminal (operation terminal for material management).

[Deletion Processing]: after a first item of AV data ordered to be deleted is deleted from a list stored in a database terminal and the relevant AV data is deleted from an AV server, a notice to the effect that the AV data has been deleted is given to each of the other operation terminals from the database terminal. At the respective operation terminals, the item of the AV data is not displayed (hidden) in the list of AV data recorded in the AV server on a screen. Subsequently, the same processing is performed continuously and repeatedly without time intervals on second and subsequent AV data materials ordered to be deleted.

If a number of materials are continuously deleted in such a manner as described above, the load (CPU utilization) at the database terminal and respective operation terminals increases. Further, there may be such a case that operation terminals may not be operated during certain minutes due to the load increase until the deletion is completed.

### SUMMARY OF THE INVENTION

Here, such load can be prevented from increasing, if AV data are deleted at specific time intervals instead of continuously deleting the data, when such AV data recorded in the AV server are collectively deleted.

However, in the case of simply deleting AV data at specific time intervals as described above, it takes time until all the items of AV data ordered to be deleted are not displayed on the screen of respective operation terminals (an item of AV data material deleted last is kept displayed on the screen for a while). Therefore, it is difficult to quickly confirm whether the data is really deleted, and as a result there may be such a case that the operation (redundant useless operation) of giving a command of deleting the data is again carried out. In addition, there may be such a case that the AV data is recognized incorrectly as a material not to be deleted during a period of the item thus displayed on the screen and a certain operation (invalid erroneous operation since the data will actually be deleted afterward) may be performed based on such recognition.

It is desirable to prevent load from increasing when collectively deleting data and to prevent an erroneous operation from being performed on data to be deleted, in a data management system such as above-described AV server system which includes a management terminal for performing an operation of giving a command of deleting data recorded in a recording apparatus.

According to an embodiment of the present invention, there is provided a data management system including a management terminal for displaying a list of data recorded in a recording apparatus on a screen to perform an operation of giving a command of deleting the data an item of which is displayed in the list on the screen. The data management system includes a non-display processor and a deletion processor. The non-display processor is configured to immediately hide all the items of data ordered to be deleted in the list on the screen upon receiving the command of deleting the data given with the operation performed at the management terminal. The deletion processor is configured to delete respective data ordered to be deleted from the recording apparatus at specific time intervals after the command of deleting the data is given with the operation performed at the management terminal.

According to the data management system, all the items of data ordered to be deleted are immediately hidden on the screen of the management terminal when the command of deleting the data is given from the management terminal. Further, respective data ordered to be deleted are deleted from the recording apparatus at specific time intervals after the command of deleting the data is given. Since respective data are deleted at specific time intervals as described above, it is possible to prevent the load from increasing when deleting data collectively.

Further, according to the embodiment, the deletion processing and the display processing on the screen, which have been synchronized in the past, may not be synchronized so that the items of the data ordered to be deleted is immediately (before the data being actually deleted) hidden on the screen. Therefore, it is confirmed easily that the data will be deleted. Accordingly, an operation of giving a command of deleting the data is prevented from being performed again and an operation based on an erroneous recognition that the data is not to be deleted is prevented from being performed.

The data management system may further include a database terminal configured to store the list of data recorded in the recording apparatus and other operation terminals than the management terminal. In the data management system, the list of data recorded in the recording apparatus is displayed on screens of the management terminal and the other operation terminals respectively based on the list stored in the database terminal. Processing of notifying the database terminal of the data ordered to be deleted is performed with the operation at the management terminal. Processing of adding deletion reservation information to all the data ordered to be deleted in the list is performed at the database terminal based on the notice. Further, processing of causing all the items of the data, to which the deletion reservation information is added, to be immediately hidden on the respective screens is performed at the management terminal and the operation terminals. Thus, the non-display processor is configured to hide the items of the data ordered to be deleted in the list through such notifying processing, adding processing and non-display processing. The deletion processor is configured to delete the items of the data, to which the deletion reservation information is added, from the list stored in the database terminal and delete the data from the recording apparatus at specific time intervals.

As described above, the database terminal configured to store the list of data recorded in the recording apparatus adds the deletion reservation information to all the data ordered to be deleted by the management terminal. Further, the management terminal and other operation terminals cause all the items of the data, to which the deletion reservation information is added, to be immediately hidden on the screen. Accordingly, the data to be deleted may be confirmed easily not only at the management terminal but also at the other operation terminals than the management terminal so that an erroneous operation can be prevented from being performed on such data.

According to an embodiment of the present invention, the following effects can be obtained in a data management system including a management terminal for performing an operation of giving a command of deleting data recorded in a recording apparatus. According to the data management system, load is prevented from increasing when collectively deleting data, since respective data are deleted at specific time intervals. Further, an item of data ordered to be deleted is immediately (before the data being actually deleted) hidden on a screen, thereby preventing the operation of giving the command of deleting such data from being performed again and preventing the operation based on such erroneous recognition that the data is not to be deleted from being performed.

Further, the database terminal configured to store the list of the data recorded in the recording apparatus may add the deletion reservation information to all the data ordered to be deleted by the management terminal. The management terminal and other operation terminals may cause all the items of the data, to which the deletion reservation information is added, to be immediately hidden on the screen. In such a case, it is possible to obtain such effects that the data to be deleted can easily be confirmed not only at the management terminal but also at the other operation terminals so that an erroneous operation can be prevented from being performed on such data.

### BRIEF DESCRIPTION OF THE DRAWINGS

FIG. 1 is a diagram showing a configuration example of an AV server system to which an embodiment of the present invention is applied.

FIG. 2 is a diagram showing a screen of Trash displayed on a material management terminal.

FIG. 3 is a diagram showing a deletion interval setting screen displayed on the material management terminal.

FIG. 4 is a diagram showing an actual measurement example of CPU utilization in the case where contents are continuously deleted.

FIGS. 5A and 5B are diagrams showing actual measurement examples of CPU utilization in the case where contents are deleted at specific time intervals.

FIGS. 6A to 6C are diagrams showing processing of respective terminals upon an operation of deleting the contents.

FIGS. 7A and 7B are diagrams showing screens of Trash before and immediately after the command of deleting the contents is given.

### DESCRIPTION OF THE PREFERRED EMBODIMENTS

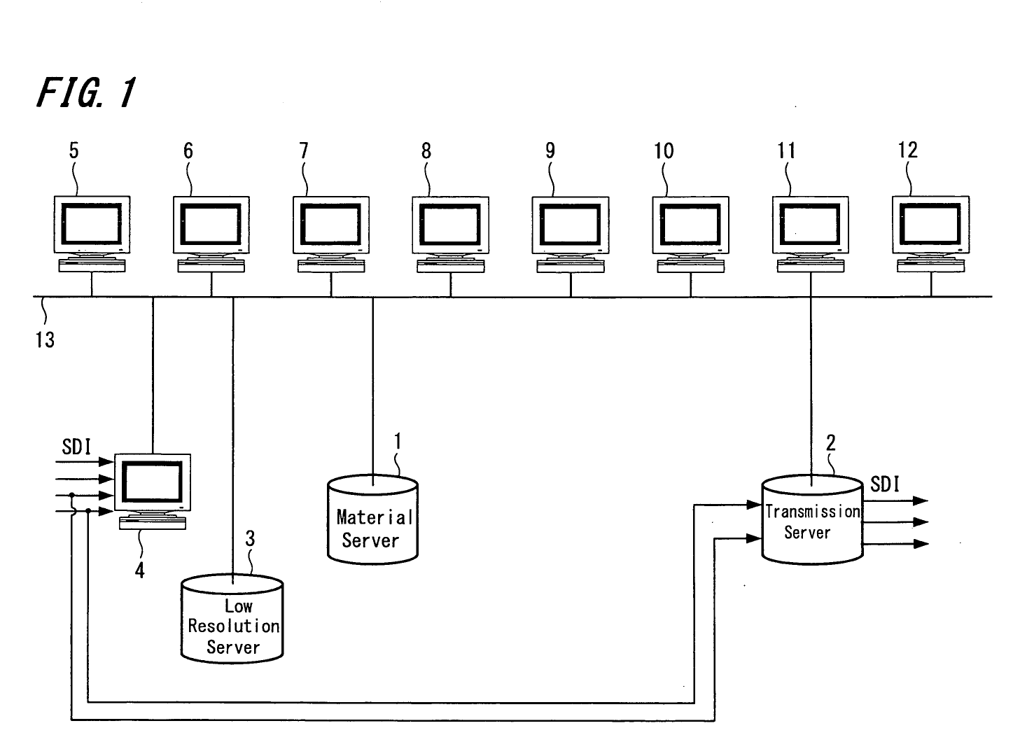

Hereinafter, an embodiment of the present invention will be described specifically with reference to the accompanied drawings. FIG. 1 is a diagram showing a configuration example of an AV server system provided in a television broadcasting station to which an embodiment of the present invention is applied. The AV server system includes: a material server 1, a transmission (playout) server 2, a low resolution server 3, a file conversion terminal 4, a recording terminal 5, an editing terminal 6, a playout manager terminal 7, a file conversion terminal 8, a database terminal 9, a material management terminal 10, a transmission terminal 11 and a data deletion terminal 12, which are connected through a network 13 such as gigabit Ethernet®.

The material server 1, transmission server 2 and low resolution server 3 are large capacity AV servers using RAID (Redundant Arrays of Inexpensive Disks) technology, respectively. The material server 1 is used to record a material (AV data) to be edited. The transmission server 2 is used to record a material to be transmitted. The low resolution server 3 is used to record AV data of low resolution (AV data for proxy image) having one-to-one correspondence to respective AV data recorded in the material server 1 and transmission server 2.

Each of the terminals 4 through 12 is formed of a computer (personal computer or workstation).

The database terminal 9 is a terminal configured to store a list of materials recorded in the material server 1 and transmission server 2, information on the setting status of the AV server system, and the like.

The recording terminal 5, editing terminal 6, material management terminal 10 and transmission terminal 11 are operation terminals configured to perform recording, non-linear editing, management (including deletion) and transmission of materials, respectively. A list of files (hereinafter, each file is also referred to as “content”) which are presently recorded in the material server 1 and transmission server 2 is displayed on screens at those terminals 5, 6, 10 and 11 based on the list stored in the database terminal 9, respectively.

In addition, the recording terminal 5, editing terminal 6, material management terminal 10 and transmission terminal 11 are configured to perform an operation of dumping an unnecessary content among contents presently recorded in the material server 1 and transmission server 2 to “Trash”. Trash is a file management function provided to OS of a computer. The above-described terminals 5, 6, 10 and 11 are also configured to perform an operation of restoring the content in Trash into the original state. The operation of Trash performed at any of the recording terminal 5, editing terminal 6, material management terminal 10 and transmission terminal 11 is reflected through the database terminal 9 in the screen of Trash displayed on the remaining terminals among the recording terminal 5, editing terminal 6, material management terminal 10 and transmission terminal 11. However, an operation of giving a command of deleting contents in Trash can be performed only at the material management terminal 10.

The file conversion terminal 4 is a background terminal configured to perform the following operations upon an operation at the recording terminal 5. The file conversion terminal 4 performs an operation of converting a serial digital signal into an image file of high resolution and of low resolution. Such serial digital signal of SDI format (Serial Digital Interface) is supplied to the AV server system from a communication line connecting a broadcasting station and a reporting site or the like and from a VTR in the broadcasting station (not shown). Those files of high resolution are recorded in the material server 1 and the files of low resolution are recorded in the low resolution server 3. It should be noted that the transmission server 2 includes an encoder and a decoder supporting the SDI format so that a material linearly edited in the VTR can also be recorded directly in the transmission server 2 upon the operation performed at the recording terminal 5.

The file conversion terminal 8 is a background terminal configured to perform the following operation upon an editing operation performed at the editing terminal 6. The file conversion terminal 8 receives a plurality of files to be edited from the material server 1 and prepares a processed and integrated file based on the content of editing. Subsequently, the file conversion terminal 8 prepares a file of low resolution corresponding thereto and then, those files are recorded in the transmission server 2 and low resolution server 3.

The playout manager terminal 7 is a background terminal configured to perform the following operation upon a transmission operation performed at the transmission terminal 11. The playout manager terminal 7 encodes the file to be transmitted into a serial digital signal of SDI format and outputs the result to a routing switcher (not illustrated) in a broadcasting station from the transmission server 2.

The data deletion terminal 12 is a background terminal configured to cause the material server 1, transmission server 2, low resolution server 3 and database server 9 to delete the data upon an operation of deleting contents (the above-described operation of deleting the contents in Trash) performed at the material management terminal 10.

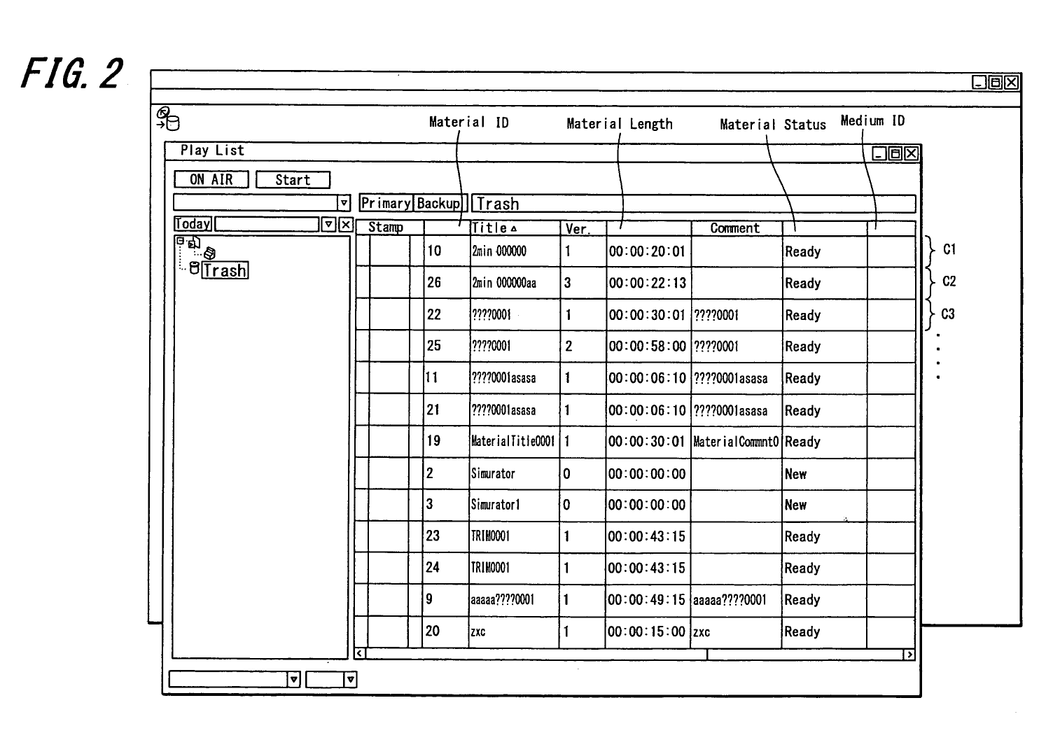

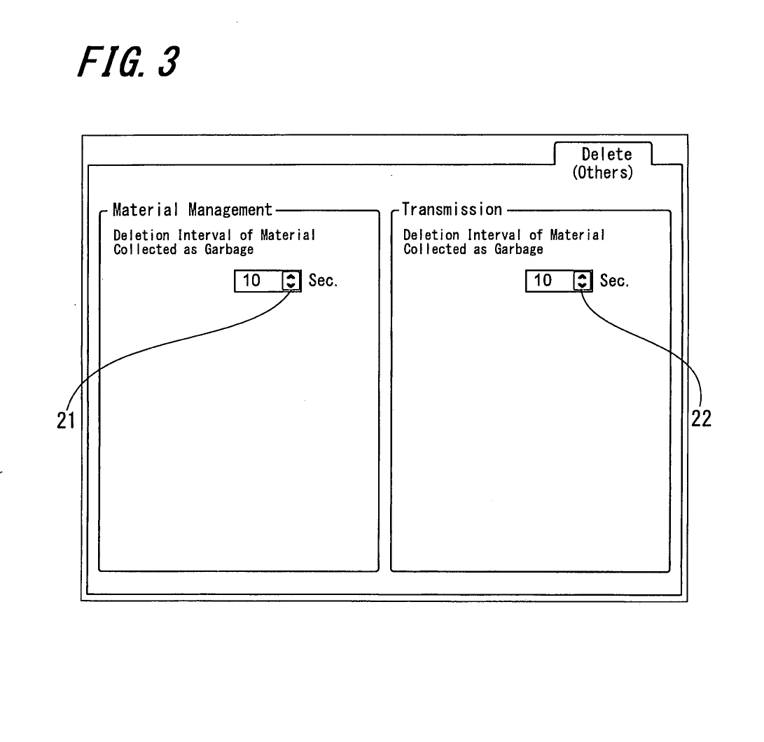

FIGS. 2 and 3 are diagrams showing screens related to an embodiment of the present invention among screens displayed on the material management terminal 10. Among those screens, FIG. 2 indicates the screen of Trash. Among contents presently recorded in the material server 1 and transmission server 2, items of contents C1, C2, C3, - - - , which have been moved to Trash at any of the recording terminal 5, editing terminal 6, material management terminal 10 and transmission terminal 11, are displayed as a list on the screen of Trash. Although a thumbnail picture is displayed in each of cells for “Stamp” at the left end of rows for respective contents, an illustration of the thumbnail picture is omitted in the figure.

The material management terminal 10 can give a command of collectively deleting contents in Trash and a command of selectively deleting part of the contents in Trash with a similar operation to that performed on the screen of Trash in a typical operating system (OS) of a computer. As described above, the screen of Trash is further displayed on the recording terminal 5, editing terminal 6 and transmission terminal 11, however, the operation of giving the command of deleting the contents in Trash may not be performed at those terminals.

FIG. 3 is a diagram showing a deletion interval setting screen. A pull-down menu 21 and a pull-down menu 22 are displayed on the screen. The pull-down menu 21 (on the left) is used to select a time interval when deleting contents recorded in the material server 1 from such intervals as 3 sec, 5 sec and 10 sec. The pull-down menu 22 (on the right) is used to similarly select a time interval when deleting contents recorded in the transmission server 2.

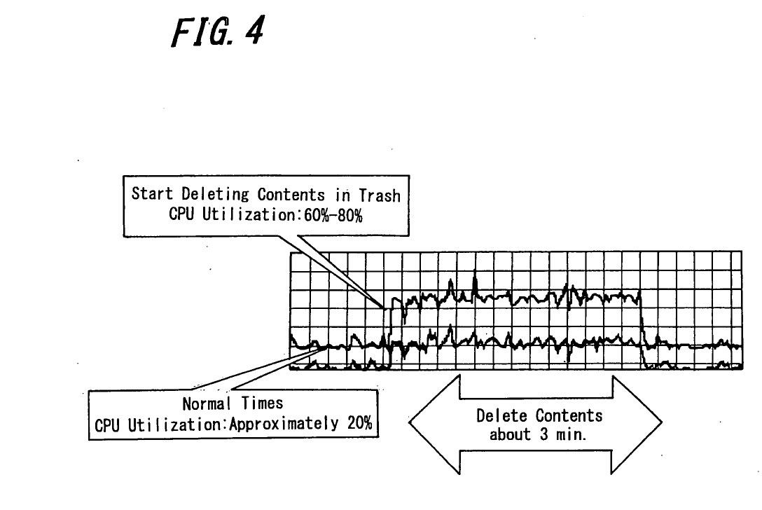

FIG. 4 is a diagram showing an actual measurement example of the load (CPU utilization) at the database terminal 9, recording terminal 5, editing terminal 6, material management terminal 10 and transmission terminal 11, in the case where 1,000 contents in Trash are continuously deleted without time intervals. In this case, the following operations are completed within three minutes from the start to the end of deletion. Specifically, the 1,000 contents recorded in the material server 1 and transmission server 2 are deleted; the corresponding 1,000 low resolution files recorded in the low resolution server 3 are deleted; the 1,000 contents are deleted from the list stored in the database terminal 9; and a deletion notice indicating that the relevant content is deleted is issued. Here, the deletion notice is given from the database terminal 9 to the recording terminal 5, editing terminal 6, material management terminal 10 and transmission terminal 11 each time when an individual content is deleted.

However, the CPU utilization has increased to approximately 60%-80% for about three minutes from the start to the end of the deletion, while the CPU utilization is normally around 20%. Hence, the operation of the recording terminal 5, editing terminal 6, material management terminal 10 and transmission terminal 11 may not be performed during the time due to such load increase.

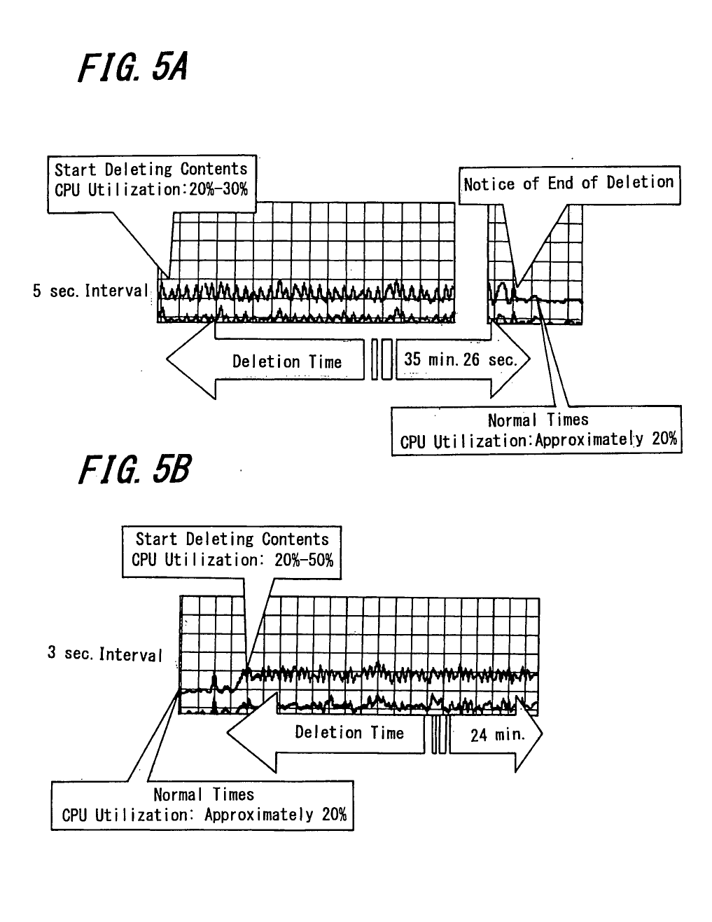

On the other hand, FIGS. 5A and 5B are diagrams showing actual measurement examples of the load at the database terminal 9, recording terminal 5, editing terminal 6, material management terminal 10 and transmission terminal 11 in the case where similarly 1,000 contents in Trash are deleted at specific time intervals (five seconds intervals in FIG. 5A, and three seconds intervals in FIG. 5B). As shown in FIG. 5A, it takes 35 minutes and 26 seconds to the completion of the deletion in the case where the deletion interval is set to five seconds; however, the CPU utilization is approximately 20%-30% (almost the same as that at normal times) during the period from the start to the end of the deletion. Also, as shown in FIG. 5B, in the case where the deletion interval is set to three seconds, it takes 24 minutes to the completion of the deletion and the CPU utilization is approximately 20%-50% during the period from the start to the end of the deletion.

According to the actual measurement examples, the load is prevented from increasing in the database terminal 9, recording terminal 5, editing terminal 6, material management terminal 10 and transmission terminal 11, if 1,000 contents in Trash are collectively deleted at intervals of five seconds between respective contents.

However, if contents are simply deleted at specific time intervals as described above and items of the deleted contents are hidden on the screen of Trash in synchronization with the deletion processing, it takes time until all the items of the contents ordered to be deleted at the material management terminal 10 are hidden on the screen of Trash. In other words, an item of the content to be deleted last may continue to be displayed on the screen of Trash for 30 minutes or more.

As a result, it may be difficult to confirm whether the content is actually deleted. Accordingly, there may be such a case that an operator operating the material management terminal 10 again performs the operation (redundant useless operation) of giving the command of deletion. Further, there may be such a case that an operator operating the material management terminal 10 or operating the recording terminal 5, editing terminal 6, or transmission terminal 11 may erroneously recognize the content is not to be deleted. Subsequently, the operator may perform an operation (invalid erroneous operation since the content is actually deleted afterward) of restoring the content from Trash based on such recognition while the content is being displayed on the screen of Trash.

According to an embodiment of the AV server system, in the case where the command of deleting the content is given from the material management terminal 10, the following processing is executed between the material management terminal 10 and each of the database terminal 9 and data deletion terminal 12, and between the database terminal 9 and each of the recording terminal 5, editing terminal 6, material management terminal 10 and transmission terminal 11.

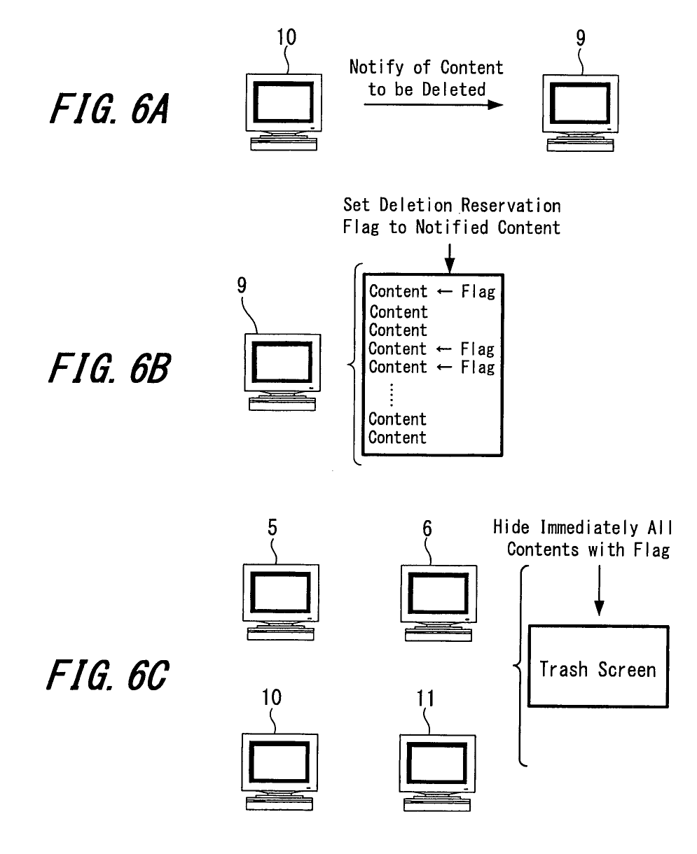

Specifically, after the intervals for deletion to be performed at the material server 1 and transmission server 2 are respectively selected on the deletion interval setting screen of FIG. 3, the command of deleting the content is given on the screen of Trash of FIG. 2. Then, the material management terminal 10 notifies the database terminal 9 of the contents ordered to be deleted as shown in FIG. 6A. In addition, the material management terminal 10 notifies the data deletion terminal 12 of a setting result of the deletion interval on the deletion interval setting screen.

Upon receiving the notice, the database terminal 9 respectively sets a flag indicating that deletion is reserved to all the contents ordered to be deleted among the contents the list of which is stored as shown in FIG. 6B.

The recording terminal 5, editing terminal 6, material management terminal 10 and transmission terminal 11 constantly monitor the flag set in the database terminal 9 and all the items of contents having the flag are immediately hidden on the screen of Trash as shown in FIG. 6C.

The data deletion terminal 12 also monitors constantly the flag that is set in the database terminal 9. The data deletion terminal 12 causes the items of the contents, to which the flags are set, to be deleted from the list stored in the database terminal 9. Further, the data deletion terminal 9 causes the contents to be deleted from the material server 1 and transmission server 2 at specific time intervals in accordance with the setting result of the deletion interval notified from the material management terminal 10. Moreover, the corresponding low resolution file recorded in the low resolution server 3 is also deleted each time the content is deleted from the material server 1 and transmission server 2.

According to the AV server system of the embodiment, since contents are respectively deleted at specific time intervals as described above, the load may be prevented from increasing when collectively deleting the contents. Furthermore, the deletion processing and the display processing on the screen of Trash are not synchronized such that items of the contents ordered to be deleted are immediately (before being actually deleted) hidden on the screen of Trash.

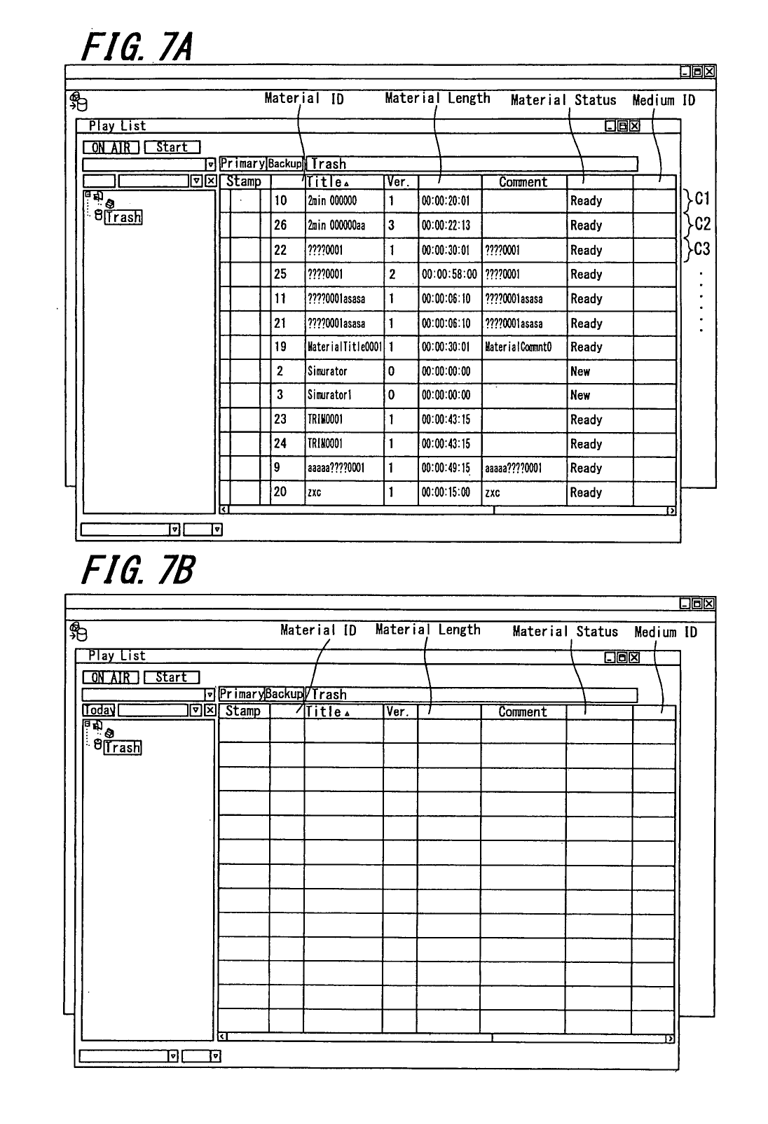

FIGS. 7A and 7B are diagrams showing the screen of Trash.

FIG. 7A shows a display screen of Trash including items of contents C1, C2, C3, - - - as shown in FIG. 2. FIG. 7B shows the screen immediately after the command of collectively deleting the contents C1, C2, - - - Cn is given from the material management terminal 10. All the items of the contents C1, C2, C3, - - - , which have been in Trash, are hidden immediately after the command is given to collectively delete those contents.

Since items of the contents ordered to be deleted are immediately (actually before being deleted) hidden on the screen of Trash as described above, it can be confirmed readily that such contents are to be deleted. Therefore, the operation (redundant operation) of again giving the command of deleting such content can be prevented from being performed Further, the operation (invalid erroneous operation) to restore the content from Trash based on such erroneous recognition that the content is not to be deleted can be prevented from being performed.

Further, the database terminal 9 adds deletion reservation information (flag) to all the contents ordered to be deleted at the material management terminal 10. Subsequently, the recording terminal 5, editing terminal 6, material management terminal 10 and transmission terminal 11 immediately cause items of all the contents, to which the deletion reservation information is added, to be hidden on the screen of Trash. As a result, not only at the material management terminal 10 but also at the recording terminal 5, editing terminal 6 and transmission terminal 11, it can be confirmed readily that such content is to be deleted. Therefore, the operation of restoring the content from Trash based on such erroneous recognition that the content is not to be deleted can be prevented.

According to the embodiment described above, the processing of deleting the contents from the material server 1, transmission server 2 and low resolution server 3 and the processing of deleting items of the contents from the list stored in the database terminal 9 are executed at the data deletion terminal 12 as a back ground terminal that is a separate terminal from the material management terminal 10. The separate terminal is provided to avoid the load from being concentrated at the material management terminal 10 alone. However, according to another embodiment of the present invention, such deletion processing may be executed at the material management terminal 10, in the case where CPU of the material management terminal 10 has sufficient processing capacity.

An embodiment of the present invention is applied to the AV server in the above-described example. However, an embodiment of the present invention may be applied to any of data management systems including a management terminal for displaying a list of data recorded in a recording apparatus on the screen to perform the operation of giving a command of deleting the data. Further, the management terminal alone may execute such operation that all the items of the data ordered to be deleted are immediately hidden on the screen in a data management system without a terminal for displaying such screen other than the management terminal and without a database terminal for storing the list of the data recorded in the recording apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. A data management system including a management terminal for displaying a list of data recorded in a recording apparatus on a screen to perform an operation of giving a command of deleting the data an item of which is displayed in the list on the screen, comprising:
non-display processing means for immediately hiding all the items of the data ordered to be deleted in the list on the screen upon receiving the command of deleting the data given with the operation performed at the management terminal; and
deletion processing means for deleting respective data ordered to be deleted from the recording apparatus at specific time intervals after the command of deleting the data is given with the operation performed at the management terminal.

2. A data management system according to claim 1, further comprising:
a database terminal configured to store a list of data recorded in the recording apparatus; and
other operation terminals than the management terminal, wherein
a list of data recorded in the recording apparatus is displayed on screens of the management terminal and the other operation terminals respectively based on the list stored in the database terminal,
processing of notifying the database terminal of the data ordered to be deleted is performed with the operation at the management terminal,
processing of adding deletion reservation information to all the data ordered to be deleted in the list is performed at the database terminal based on the notice,
processing of causing all the items of the data, to which the deletion reservation information is added, to be immediately hidden on the respective screens is performed at the management terminal and the other operation terminals,
the non-display processor is configured to hide the items of the data ordered to be deleted in the list through the notifying processing, the adding processing and the non-display processing, and
the deletion processor is configured to delete the items of the data, to which the deletion reservation information is added, from the list stored in the database terminal and delete the data from the recording apparatus at specific time intervals.

3. A data management system according to claim 1, wherein
a setting screen for setting data deletion intervals is displayed at the management terminal, and
the deletion processor is configured to delete data at the intervals set on the setting screen.

4. A data management system according to claim 1, wherein
the deletion processor is configured with a background terminal other than the management terminal.

5. A data management system including a management terminal for displaying a list of data recorded in a recording apparatus on a screen to perform an operation of giving a command of deleting the data an item of which is displayed in the list on the screen, comprising:
a non-display processor configured to immediately hide all the items of the data ordered to be deleted in the list on the screen upon receiving the command of deleting the data given with the operation performed at the management terminal; and
a deletion processor configured to delete respective data ordered to be deleted from the recording apparatus at specific time intervals after the command of deleting the data is given with the operation performed at the management terminal.
